(19) United States
(12) Patent Application Publication
(10) Pub. No.: US 2026/0225724 A1
(43) Pub. Date: Aug. 6, 2026

(54) PROPULSION SYSTEM FOR AN AIRCRAFT COMPRISING AN ENGINE MAST, A TURBINE ENGINE, AND MEANS FOR SECURING THE TURBINE ENGINE TO THE ENGINE MAST

(71) Applicant: Airbus Operations SAS, TOULOUSE (FR)

(72) Inventors: Germain GUENEAU, TOULOUSE (FR); Pierre-Antoine COMBES, TOULOUSE (FR); Nicolas CHARTON, TOULOUSE (FR)

(21) Appl. No.: 19/468,053

(22) Filed: Feb. 3, 2026

(30) Foreign Application Priority Data
Feb. 4, 2025 (FR) FR2501146

(51) Int. Cl. B64D 27/40; B64C 3/32; B64D 27/18

(52) U.S. Cl. CPC B64D 27/402; B64C 3/32; B64D 27/18

(57) ABSTRACT

A propulsion system for an aircraft comprising an engine mast with a nose, a turbojet engine having a casing, a central shackle articulated to the nose by a first connection point and articulated to the casing by two second connection points, and a lateral shackle articulated between the nose and the casing by a central connection point and two lateral connection points arranged on either side of a vertical median plane.

### CROSS-REFERENCES TO RELATED APPLICATIONS

This application claims the benefit of French Patent Application Number FR 2501146 filed on Feb. 4, 2025, the entire disclosure of which is incorporated herein by way of reference.

### FIELD OF THE INVENTION

The present invention relates to a propulsion system for aircraft, wherein the propulsion system comprises a turbojet engine, an engine mast and means for securing the turbojet engine to the engine mast, as well as to an aircraft comprising such a propulsion system.

### BACKGROUND OF THE INVENTION

An aircraft typically comprises a plurality of propulsion systems. Each propulsion system is generally attached under a wing of the aircraft and comprises an engine mast attached under the wing, a turbojet engine and fastening means for securing the turbojet engine under the engine mast.

Although current propulsion systems are satisfactory, the assembly and disassembly of the fastening means are generally time-consuming and complex, and it is desirable to find an arrangement that reduces installation time and complexity.

### SUMMARY OF THE INVENTION

One object of the present invention is to propose an aircraft propulsion system comprising a turbojet engine, an engine mast and fastening means securing the turbojet engine to the engine mast, the assembly/disassembly of which is facilitated.

To this end, a propulsion system for an aircraft is proposed, comprising:
an engine mast with a nose,
a turbojet engine having a casing extending along a longitudinal direction and having a vertical median plane,
at least one central shackle inscribed in a plane parallel to the vertical median plane, articulated to the nose by a first connection point and articulated to the casing by two second connection points, and
a lateral shackle articulated between the nose and the casing by a central connection point and two lateral connection points arranged on either side of the vertical median plane.

With such a system, the mounting of the turbojet engine to the engine mast is simplified.

According to a particular embodiment, there is a central shackle arranged at the vertical median plane.

Advantageously, the propulsion system comprises two complementary shackles arranged on either side of the vertical median plane, where each complementary shackle is inscribed in a plane parallel to the vertical median plane and is articulated to the nose by the first connection point, and is articulated to the casing by the two second connection points.

Advantageously, the nose consists of two fittings arranged on either side of the vertical median plane, each fitting having an outer extension and an inner extension, the first extension and the second extension of each fitting together forming a female clevis in which the complementary shackle on the same side of the vertical median plane is mounted to form the first connection point, and the two inner extensions together forming a female clevis in which the central shackle is mounted to form the first connection point.

According to another particular embodiment, there are two central shackles arranged on either side of the vertical median plane.

Advantageously, the nose consists of two fittings arranged on either side of the vertical median plane, each fitting having an extension attached to the extension of the other fitting, where the extensions together form a male clevis and the two central shackles together form a female clevis in which the male clevis is mounted to form the first connection point.

According to one variant, the central connection point secures the nose to the side shackle and each side connection point secures the casing to the side shackle.

Advantageously, when the nose consists of two fittings, each fitting has a front extension and a rear extension, the two front extensions together form one wall of a central female clevis, the two rear extensions together form the other wall of the central female clevis, and the side shackle forms a central male clevis mounted in the central female clevis to form the central connection point.

According to another variant, the central connection point secures the housing to the side shackle, and each side connection point secures the nose to the side shackle.

Advantageously, the first connection point and the two second connection points each form at least one pivot connection of which the axis is perpendicular to the vertical median plane, and the central connection point and the two lateral connection points each form at least one pivot connection of which the axis is parallel to the longitudinal direction.

The invention also proposes an aircraft comprising a propulsion system according to one of the preceding variants.

### BRIEF DESCRIPTION OF THE DRAWINGS

The features of the invention mentioned above, as well as others, will become clearer upon reading the following description of an exemplary embodiment, said description being made in relation to the attached drawings, in which:

FIG. 1 is a side view of an aircraft according to the invention;

FIG. 2 is a perspective view of a propulsion system according to a first embodiment of the invention;

FIG. 3 is a perspective view of the propulsion system according to the first embodiment of the invention, with parts removed;

FIG. 4 is a front view of the propulsion system according to the first embodiment;

FIG. 5 shows a detail of the propulsion system according to the first embodiment;

FIG. 6 is a front view of the propulsion system according to a second embodiment of the invention; and

FIG. 7 is a perspective view of a propulsion system according to a third embodiment of the invention.

### DETAILED DESCRIPTION OF THE PREFERRED EMBODIMENTS

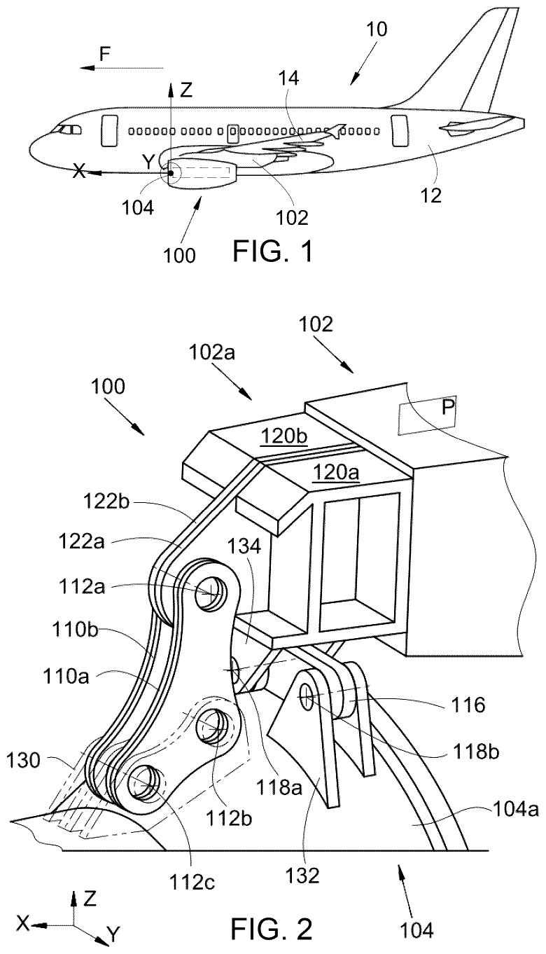

FIG. 1 shows an aircraft 10 that comprises a propulsion system 100 according to the invention. The aircraft 10 comprises, on either side of a fuselage 12, a wing 14 to which an engine mast 102 is attached. The propulsion system 100 comprises the engine mast 102 and a turbojet engine 104.

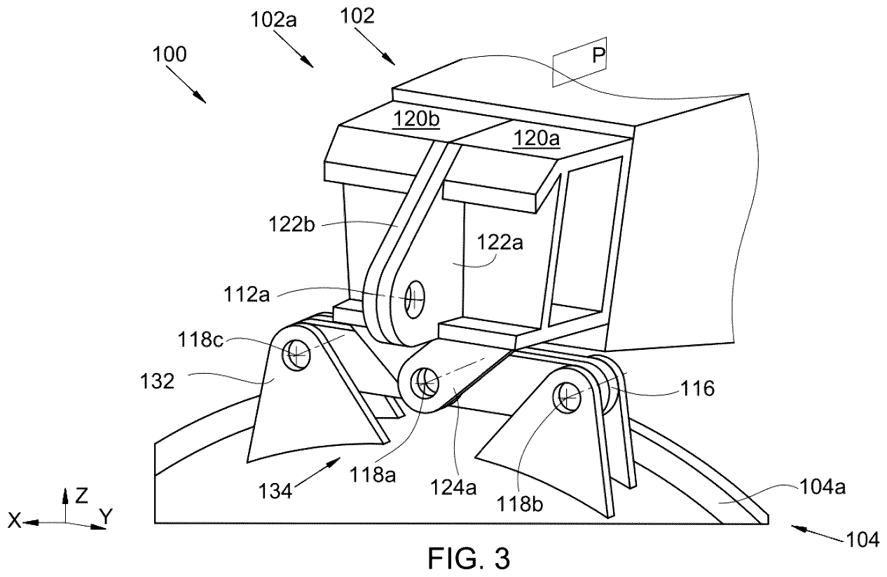

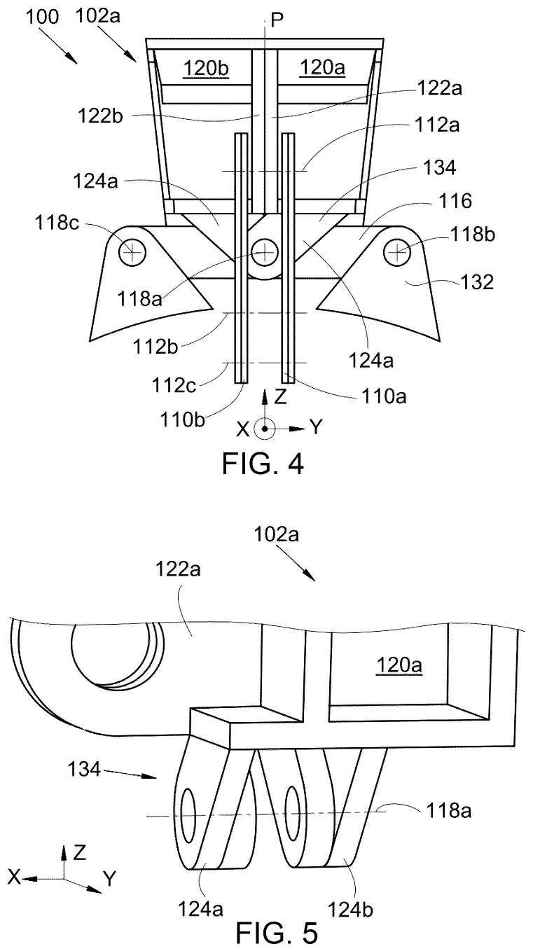

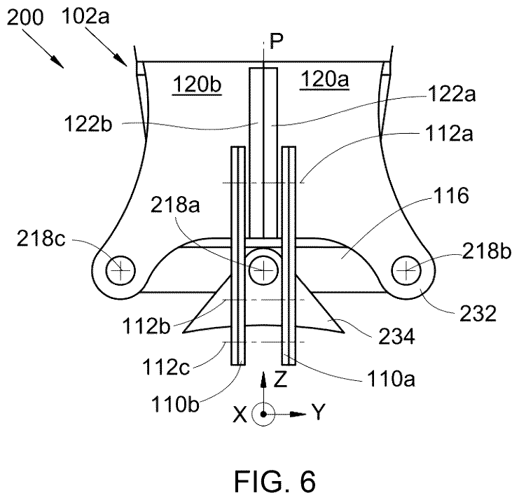

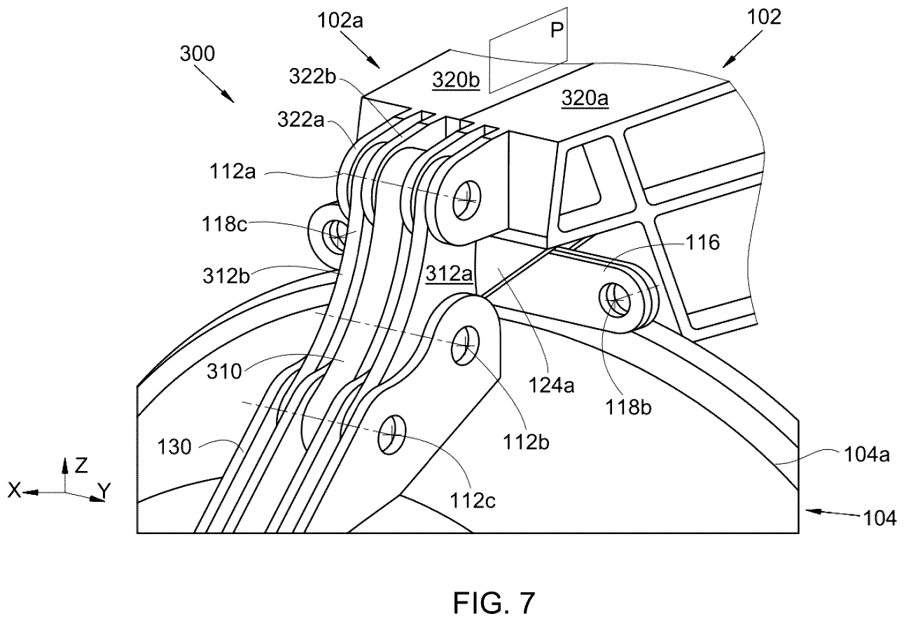

FIGS. 2 to 5 show a propulsion system 100 according to a first embodiment of the invention, FIG. 6 shows a propulsion system 200 according to a second embodiment of the invention, and FIG. 7 shows a propulsion system 300 according to a third embodiment of the invention.

The propulsion system 100, 200, 300 also comprises fastening means that secure the turbojet engine 104 to the engine mast 102.

In the following description, terms relating to position are taken with reference to an aircraft in normal flight position, i.e., as shown in FIG. 1, and the positions “front” and “rear” are taken in relation to the front and rear of the turbojet engine and in relation to the direction of travel F of the aircraft 10 when the turbojet engine 104 is operating.

In the following description, and by convention, X is the longitudinal direction of the turbojet engine 104, which is parallel to the longitudinal axis of the turbojet engine 104, Y is the transverse direction, which is horizontal when the aircraft is on the ground, and Z is the vertical direction, which is vertical when the aircraft is on the ground, these three directions X, Y and Z being orthogonal to each other.

The turbojet engine 104 has a shape of revolution about its longitudinal axis and comprises a casing 104a which extends along the longitudinal direction X and has a vertical median plane P (XZ). The propulsion system 100, 200, 300 is generally symmetrical with respect to the vertical median plane P.

The engine mast 102 has a nose 102a extending at the front of the engine mast 102.

The propulsion system 100, 200, 300 comprises at least one central shackle 110a-b, 310 inscribed in a plane parallel to the vertical median plane P. Said at least one central shackle 110a-b, 310 is articulated to the nose 102a by a first connection point 112a and is articulated to the casing 104a by two second connection points 112b-c.

The propulsion system 100, 200, 300 also comprises a lateral or side shackle 116 which is articulated between the nose 102a and the casing 104a by a central connection point 118a, 218a and by two lateral or side connection points 118b-c, 218b-c. The two lateral connection points 118b-c, 218b-c are arranged on either side of the vertical median plane P and preferably symmetrically with respect to the vertical median plane P.

With this arrangement, mounting the turbojet engine 104 to the engine mast 102 is simplified because it is sufficient to install the connection points described and there is no need to install thrust shackles fixed between the rear of the engine mast 102 and the turbojet engine 104.

The various connection points take the form of a clevis-type connection, which allows the connection points to be made simply by inserting a connecting pin between a male clevis and a female clevis.

Each central shackle 110a-b, 310 generally takes the form of a flat triangular plate with a connection point 112a-c at each corner.

The central shackle 110a-b, 310 is attached to the casing 104a of the turbojet engine 104 by means of female central clevises 130 integral with the casing 104a, where there is one female central clevis 130 per central shackle 110 a-b, 310, the latter forming a male clevis housed in the female central clevis 130 and fixed in an articulated manner by the insertion of a pin, passing through the female central clevises 130 and the central shackle(s) 110a-b, 310, through holes provided for this purpose to form a clevis connection.

Among the two second connection points 112b-c, there is a second rear connection point 112b and a second front connection point 112c located at the front in relation to the second rear connection point 112b.

The side shackle 116 is fixed at the central connection point 118a, 218a and at each side connection point 118b-c, 218b-c by means of clevis-type connections, where the side shackle 116 forms the male clevis housed and mounted in a female clevis by inserting a pin through the clevises. The axis of each clevis connection is parallel here to the longitudinal direction X.

The pin of the central connection point 118a, 218a is included in the vertical median plane P and the pins of the lateral connection points 118b-c, 218b-c are arranged symmetrically on either side of the vertical median plane P.

The length of the lateral shackle 116 extending between the lateral connection points 118b-c, 218b-c is perpendicular to the vertical median plane P.

The forces in X and Y are absorbed by each central shackle 110a-b, 310 and the forces in Y are absorbed by the lateral shackle 116.

For safety reasons, the side shackle 116 is double here, i.e. it consists of two identical sub-shackles joined together.

In the first and second embodiments shown here, there are two central shackles 110a-b which are arranged on either side of the vertical median plane P. For safety reasons, in the first and second embodiments, the nose 102a consists of two fittings 120a-b which are independent of each other and are arranged on either side of the vertical median plane P. Each fitting 120a-b has an extension 122a-b that extends towards the front of the nose 102a and is attached to the extension 122b-a of the other fitting 120b-a, i.e., along the vertical median plane P.

The extensions 122a-b thus together form a male clevis, and the two central shackles 110a-b together form a female clevis in which the male clevis is mounted in an articulated manner to form the first connection point 112a. To this end, a through pin is inserted into the clevises through holes provided for this purpose to form the clevis connection of the first connection point 112a.

For safety reasons, each central shackle 110a-b is double, i.e. it consists of two identical sub-shackles joined together.

The two sub-shackles forming a central shackle 110a-b are housed in a female central clevis 130 and form a wall of the female clevis of the first connection point 112a.

In the third embodiment, there is a central shackle 310 disposed at the vertical median plane P and, for safety reasons, the propulsion system 300 also comprises two complementary shackles 312a-b which are disposed on either side of the vertical median plane P.

Each complementary shackle 312a-b is thus inscribed in a plane parallel to the vertical median plane P and is articulated to the nose 102a by the first connection point 112a, and articulated to the casing 104a by the two second connection points 112b-c. Each complementary shackle 312a-b therefore has a shape and location similar to those of the central shackle 310.

For safety reasons, in the third embodiment, the nose 102a consists of two fittings 320a-b which are independent of each other and are arranged on either side of the vertical median plane P. Each fitting 320a-b has an outer extension 322a and an inner extension 322b towards the front of the nose 102a. The inner extensions 322b of the two fittings 320a-b are thus opposite each other and on either side of the vertical median plane P, and each outer extension 322a is outside the associated inner extension 322b. The inner extension 322b is closer to the vertical median plane P than the associated outer extension 322a.

The first extension 322a and the second extension 322b of each fitting 320a-b together form a female clevis in which the complementary shackle 312a-b, which is on the same side of the vertical median plane P, is mounted to form the first connection point 112a, and the two inner extensions 322b are spaced apart from each other and together form a female clevis in which the central shackle 310 is mounted to form the first connection point 112a.

To this end, a pin is housed, passing through the extensions 322a-b and the complementary shackles 312a-b and the central shackle 310 through holes provided for this purpose to achieve the clevis connection of the first connection point 112a.

The complementary shackles 312a-b and the central shackle 310 are each housed in a female central clevis 130.

The first and third embodiments show a first specific arrangement for the side shackle 116, and the second embodiment shows a second specific arrangement for the side shackle 116. It is also possible to combine the third embodiment with the second specific arrangement.

In the first specific arrangement, the central connection point 118a secures the nose 102a to the side shackle 116, and each side connection point 118b-c secures the casing 104a to the side shackle 116.

The nose 102a thus comprises a central female clevis 134 in which the side shackle 116 is housed and where a pin is housed, passing through the side shackle 116 and the central female clevis 134 through holes provided for this purpose to form the clevis connection of the central connection point 118a.

The casing 104a has, on either side of the vertical median plane P, a lateral female clevis 132 in which the lateral shackle 116 is housed and where a pin is housed, passing through the lateral shackle 116 and the lateral female clevis 132 through holes provided for this purpose to form the clevis connection of each lateral connection point 118b-c.

In this first arrangement, which is best seen in FIG. 5, when the nose 102a consists of the two fittings 120a-b, 320a-b, each fitting 120a-b, 320a-b has a front extension 124a and a rear extension 124b. Each extension 124a-b extends towards the casing 104a, and the front extension 124a is positioned in front of the rear extension 124b.

In the particular embodiment shown in FIG. 5, the front extension 124a of the port fitting 120a is arranged forward of the front extension 124a of the starboard fitting 120b, and the rear extension 124b of the starboard fitting 120b is arranged forward of the rear extension 124b of the port fitting 120a. The two front extensions 124a are forward of the two rear extensions 124b.

The two front extensions 124a can be joined together and the two rear extensions 124b can be joined together. There is a space between the two front extensions 124a and the two rear extensions 124b to form the central female clevis 134. Alternatively, the two front extensions 124a and the two rear extensions 124b are not joined together.

The two front extensions 124a thus together form one wall of the central female clevis 134 and the two rear extensions 124b thus together form the other wall of the central female clevis 134. The side shackle 116 forms the central male clevis and is mounted in the central female clevis 134 by means of a pin passing through the side shackle 116 and each extension 124a-b through holes provided for this purpose to form the central connection point 118a.

In the second arrangement, which is best seen in FIG. 6, the central connection point 218a secures the housing 104a to the side shackle 116, and each side connection point 218b-c secures the nose 102a to the side shackle 116.

The nose 102a thus comprises, for each lateral connection point 218b-c, on either side of the vertical median plane P, a female side clevis 232 in which the side shackle 116 is housed, and where a pin is housed, passing through the side shackle 116 and the female side clevis 232 through holes provided for this purpose to form the clevis connection of each side connection point 218b-c.

The casing 104a has a central female clevis 234 in which the side shackle 116 is housed and where a pin is housed, passing through the side shackle 116 and the central female clevis 234 through holes provided for this purpose to form the clevis connection of the central connection point 218a.

In the second embodiment of the invention, the first connection point 112a and the two second connection points 112b-c each form a pivot connection of which the axis of rotation is perpendicular to the vertical median plane P.

In the first and third embodiments of the invention, the first connection point 112a and the two second connection points 112b-c each form a pivot connection of which the axis of rotation is perpendicular to the vertical median plane P but preferably a ball-and-socket connection.

The complementary shackles 312a-b then constitute standby safety shackles that only become active in the event of a failure of the central shackle 310 constituting the main stress path. The axis of the clevis link of the first connection point 112a is thus mounted with play in the holes associated with the complementary shackles 312a-b and by a ball-and-socket joint in the hole associated with the central shackle 310.

In each of the embodiments, the central connection point 118a, 218a and the two lateral connection points 118b-c, 218b-c each form at least one pivot connection of which the axis is parallel to the longitudinal direction X, but preferably, the central connection point 118a, 218a and one of the two lateral connection points 118b-c, 218b-c form a ball-and-socket joint.

The other lateral connection point 118c-b, 218c-b then constitutes a standby safety point that only becomes active in the event of a failure of the main stress path. The axis of said other lateral connection point 118c-b, 218c-b is thus mounted with play in the associated holes.

In general, for safety reasons, the pin of each clevis connection may be doubled and may thus comprise an inner pin housed in a hollow outer pin.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority. Claimed is:

1. A propulsion system for an aircraft comprising:
an engine mast with a nose;
a turbojet engine having a casing extending along a longitudinal direction and having a vertical median plane;
at least one central shackle inscribed in a plane parallel to the vertical median plane, the at least one central shackle articulated to the nose by a first connection point and articulated to the casing by two second connection points; and
a lateral shackle articulated between the nose and the casing by a central connection point and two lateral connection points arranged on either side of the vertical median plane.

2. The propulsion system according to claim 1, further comprising:
a central shackle arranged at the vertical median plane.

3. The propulsion system according to claim 2, further comprising:
two complementary shackles arranged on either side of the vertical median plane, where each of the two complementary shackles is inscribed in a plane parallel to the vertical median plane and is articulated to the nose by the first connection point, and is articulated to the casing by the two second connection points.

4. The propulsion system according to claim 3, wherein the nose comprises two fittings arranged on either side of the vertical median plane,
wherein each of the two fittings has an outer extension and an inner extension which together form a female clevis in which a complementary shackle, of the two complementary shackles, which is on a same side of the vertical median plane is mounted to form the first connection point, and
wherein the inner extensions together form a second female clevis in which the central shackle is mounted to form the first connection point.

5. The propulsion system according to claim 1, wherein the at least one central shackle comprises two central shackles arranged on either side of the vertical median plane.

6. The propulsion system according to claim 5, wherein the nose comprises two fittings arranged on either side of the vertical median plane,
wherein each fitting of the two fittings has an extension and the extension of one fitting of the two fittings connects with the extension of the other fitting of the two fittings to form a male clevis, and
wherein the two central shackles together form a female clevis in which the male clevis is mounted to form the first connection point.

7. The propulsion system according to claim 1, wherein the central connection point provides a connection between the nose and the lateral shackle,
and wherein each side connection point provides a connection between the casing and the lateral shackle.

8. The propulsion system according to claim 7, further comprising:
a central shackle arranged at the vertical median plane; and,
two complementary shackles arranged on either side of the vertical median plane, where each of the two complementary shackles is inscribed in a plane parallel to the vertical median plane and is articulated to the nose by the first connection point, and is articulated to the casing by the two second connection points,
wherein the nose comprises two fittings arranged on either side of the vertical median plane,
wherein each fitting of the two fittings has a front extension and a rear extension,
wherein the two front extensions together form a first wall of a central female clevis,
wherein the two rear extensions together form a second wall of the central female clevis, and
wherein the lateral shackle forms a central male clevis mounted in the central female clevis to form the central connection point.

9. The propulsion system according to claim 1, wherein the central connection point provides a connection between the casing and the lateral shackle, and
wherein each side connection point provides a connection between the nose and the lateral shackle.

10. The propulsion system according to claim 1, wherein the first connection point and the two second connection points each form at least one pivot connection having an axis perpendicular to the vertical median plane, and
wherein the central connection point and the two lateral connection points each form at least one pivot connection having an axis is parallel to the longitudinal direction.

11. An aircraft comprising:
the propulsion system according to claim 1.
